(19) United States
(12) Patent Application Publication
(10) Pub. No.: US 2025/0042562 A1
(43) Pub. Date: Feb. 6, 2025

(54) DEVICE AND METHOD FOR THE SELECTIVE MODIFICATION OF POSITION INFORMATION FOR A THROTTLE LEVER IN AN AIRCRAFT

(71) Applicant: AIRBUS OPERATIONS SAS, Toulouse (FR)

(72) Inventors: Luc BRUNEL, Toulouse (FR); Patrick RINGEARD, Toulouse (FR); Patrick JEGU, Toulouse (FR); Xavier COLLAS, Toulouse (FR); Quentin-Alexandre FLAMANT-BATI, Toulouse (FR)

(73) Assignee: AIRBUS OPERATIONS SAS, Toulouse (FR)

(21) Appl. No.: 18/791,073

(22) Filed: Jul. 31, 2024

(30) Foreign Application Priority Data
Aug. 4, 2023 (FR) 2308481

(51) Int. Cl. B64D 31/06

(52) U.S. Cl. CPC B64D 31/06

(57) ABSTRACT

A method for the selective modification of position information for a throttle lever. The method is implemented by a device configured to receive position information representing a current position of the throttle lever. The method includes determining that a predefined situation is encountered when a flight condition associated with the predefined situation is verified, and obtaining, for each encountered predefined situation, a category, a duration and an expected position of the throttle lever. The method includes modifying the received position information by replacing it with the expected position, when the flight condition and a validity condition of the category are simultaneously verified for said obtained duration, and sending the modified position information in the event of a modification to a control device of the propulsion engine. Thus, it is possible to automatically influence the thrust of the engine when required by the situation.

### TECHNICAL FIELD

The present invention relates to the field of controlling an aircraft propulsion engine and more specifically relates to a method for selectively modifying information representing a position of the throttle lever of the propulsion engine in order to influence a thrust computation when predefined situations are encountered.

### PRIOR ART

Each aircraft propulsion engine is associated with a throttle lever whose physical position allows a device for controlling the propulsion engine to compute the thrust of the propulsion engine.

According to a first operating mode, called manual mode, the thrust of the propulsion engine is determined as a function of the physical position of the throttle lever.

According to a second operating mode, called automatic thrust mode, the thrust of the propulsion engine is determined as a function of other parameters, but must not exceed a maximum threshold determined by the physical position of the throttle lever.

The situation can be improved. It is worthwhile providing a solution that allows the thrust computation to be influenced when the situation requires and when a crew does not act on the throttle lever in the manner expected for the encountered situation.

Notably, it is worthwhile providing a solution that can be easily integrated into an existing system, without modifying existing devices, such as the device for controlling the propulsion engine.

### DISCLOSURE OF THE INVENTION

One aim of the present invention is to propose a method for the automated modification of position information of a throttle lever associated with a propulsion engine, the method being implemented by a device configured to receive position information representing a current position of the throttle lever, the method comprising the following steps of: determining that a predefined situation from a list of predefined situations is encountered when a condition, called flight condition, associated with the predefined situation is verified, with each predefined situation representing a flight situation in which actuating the throttle lever is deemed necessary; obtaining, for each encountered predefined situation, a category associated with said predefined situation, with each predefined situation being associated with a category from among predefined categories and each category representing a predefined piloting context, and obtaining a predefined activation duration associated with the encountered predefined situation and an expected predefined position of the throttle lever in said encountered predefined situation; assessing a condition, called validity condition, associated with the obtained category; modifying the received position information, by replacing the current position of the throttle lever with the obtained expected predefined position of the throttle lever, when the flight condition associated with the encountered predefined situation and the validity condition of the category associated with said predefined situation are simultaneously verified for a duration at least equal to said obtained predefined activation duration; and sending the modified position information in the event of a modification, and the received position information otherwise, to a control device for controlling the propulsion engine.

It is thus possible to automatically modify the position information and therefore automatically influence the thrust of the propulsion engine when the situation requires, in other words, when actuating the throttle is deemed necessary in a flight situation and when the actuation is not carried out by the crew, without modifying the device for controlling the propulsion engine.

According to a particular embodiment, the predefined categories comprise a first category having a verified validity condition when a crew is previously declared unfit, and the activation duration, associated with each first category predefined situation, is zero.

In a particular embodiment, the predefined categories comprise a second category having a verified validity condition when a crew is not previously declared unfit, and the activation duration, associated with each second category predefined situation, depends on the predefined situation.

According to a particular embodiment, the predefined categories comprise a third category having an always verified validity condition, and the activation duration, associated with each third category predefined situation, is zero.

According to a particular embodiment, the expected predefined position of the throttle lever associated with at least one predefined situation from the list of predefined situations comprises a first predefined position and a second predefined position, and modifying the received position information by replacing the current position of the throttle lever with the obtained expected predefined position of the throttle lever comprises carrying out a first modification of the position information by replacing the current position of the throttle lever with the first predefined position, and carrying out a second modification of the position information by replacing the current position of the throttle lever with the second predefined position, with the second modification of the position information being carried out after a predefined time associated with the predefined situation has elapsed, starting from the first modification.

The invention also relates to a device for the automated modification of position information for a throttle lever of an aircraft propulsion engine, with the automated selective modification device comprising electronic circuitry configured to receive position information representing a current position of the throttle lever. The device comprises electronic circuitry configured for: determining that a predefined situation from a list of predefined situations is encountered when a condition, called flight condition, associated with the predefined situation is verified, with each predefined situation representing a flight situation in which actuating the throttle lever is deemed necessary; obtaining, for each encountered predefined situation, a category associated with said predefined situation, with each predefined situation being associated with a category from among predefined categories and each category representing a predefined piloting context, and obtaining a predefined activation duration associated with the encountered predefined situation and an expected predefined position of the throttle lever in said encountered predefined situation; assessing a condition, called validity condition, associated with the obtained category; modifying the received position information, by replacing the current position of the throttle lever with the obtained expected predefined position of the throttle lever, when the flight condition associated with the encountered predefined situation and the validity condition of the category associated with said predefined situation are simultaneously verified for a duration at least equal to said obtained predefined activation duration; and sending the modified position information in the event of a modification, and the received position information otherwise, to a control device for controlling the propulsion engine.

A computer program is also proposed herein that can be stored on a medium and/or downloaded from a communications network, in order to be read by a processor. This computer program comprises instructions for implementing the aforementioned method in any one of the embodiments thereof, when said program is executed by the processor. The invention also relates to an information storage medium storing such a computer program.

### BRIEF DESCRIPTION OF THE DRAWINGS

The aforementioned features of the invention, as well as other features, will become more clearly apparent upon reading the following description of at least one embodiment, with said description being provided with reference to the attached drawings, in which:

FIG. 1 schematically illustrates an aircraft comprising an automated selective modification device for a system for controlling a propulsion engine;

FIG. 2 schematically illustrates the system for controlling a propulsion engine of the aircraft;

FIG. 3 schematically illustrates a method for the selective modification of information representing a position of a throttle lever of the propulsion engine; and

FIG. 4 schematically illustrates an example of a hardware platform for implementing the automated modification device.

### DETAILED DISCLOSURE OF EMBODIMENTS

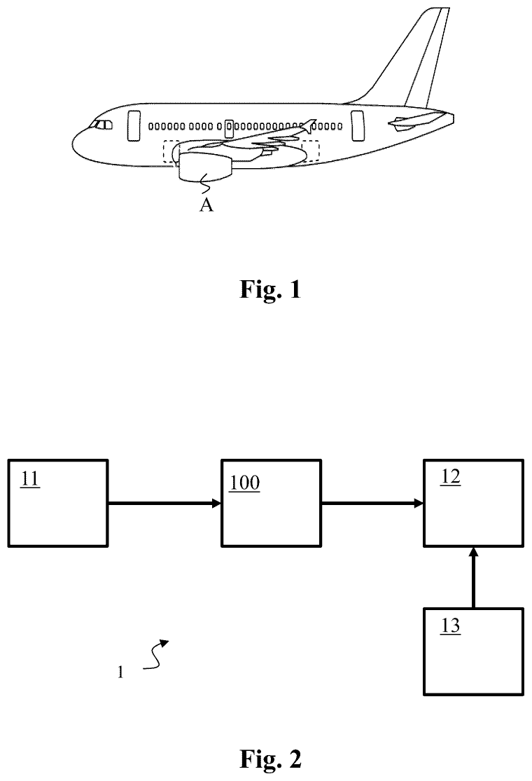

FIG. 1 schematically illustrates an aircraft A comprising an automated selective modification device for a system 1 for controlling a propulsion engine.

With reference to FIG. 2, the system 1 for controlling a propulsion engine of the aircraft A comprises a throttle lever 11, a device 12 for controlling the propulsion engine and a device 13 for managing an automatic thrust mode. The throttle lever 11 is actuated by a crew in order to vary its position. Each time the throttle lever 11 is actuated, said throttle lever 11 transmits position information representing a current position of the throttle lever 11.

The control device 12 receives position information, representing a position of the throttle lever 11, and is configured to determine the thrust of the propulsion engine by taking into account the received position information. In a first operating mode, called manual mode, the control device 12 determines the thrust as a function of said received position information. In a second operating mode, called automatic thrust mode, the thrust is determined by the management device 13 and is transmitted to the control device 12 via a communication link. The control device 12 determines a maximum thrust threshold as a function of the received position information, with the maximum thrust threshold being a threshold that must not be exceeded. In other words, when the management device 13 transmits a thrust value that is greater than the maximum thrust threshold to the control device 12, the control device 12 limits the thrust to said maximum thrust threshold.

The device 13 for managing the automatic thrust mode is configured to determine the thrust of the propulsion engine as a function of parameters of the aircraft A.

The control system 1 further comprises an automated selective modification device 100. The automated selective modification device 100 is configured to receive, from the throttle lever 11, each item of position information transmitted by the throttle lever 11. The automated selective modification device 100 is further configured to conditionally modify the received position information and to send the modified position information to the propulsion engine control device 12 in the event of a modification, and to send the received position information otherwise.

The conditional modification of the received position information is carried out by the automated selective modification device 100 when a predefined situation, from among a list of predefined situations, is detected and when said predefined situation is maintained for an activation threshold duration associated with the detected predefined situation and when a validity condition of a category associated with said predefined situation is still met during said activation threshold duration.

To this end, the automated selective modification device 100 assesses, for each predefined situation from the list of predefined situations, a condition, called flight condition, associated with said predefined situation. When the flight condition associated with one of said predefined situations is verified, said predefined situation is encountered and detected. The automated selective modification device 100 then obtains a category, from among predefined categories, that is associated with the encountered predefined situation, and assesses a condition, called validity condition, associated with said category. The automated selective modification device 100 also obtains, for each encountered predefined situation, a predefined activation duration associated with the detected predefined situation and an expected predefined position of the throttle lever 11 in the detected predefined situation.

Each item of information associated with the encountered predefined situation, such as the category, the predefined activation duration or the expected predefined position of the throttle lever 11, can be obtained, for example, by means of a request in a database based on an item of information representing the detected predefined situation. When the flight condition and the validity condition of the category associated with the encountered predefined situation are verified simultaneously for a duration that is at least equal to the obtained predefined activation duration, the automated selective modification device 100 modifies the received position information originating from the throttle lever 11, by replacing the current position of the throttle lever 11 with the expected predefined position of the throttle lever 11 associated with the detected predefined situation.

Each predefined position of the throttle lever 11 defines a thrust of the propulsion engine. Thus, if the position information is modified by the automated selective modification device 100, the control device 12 computes the thrust as a function of the predefined position of the throttle lever 11 associated with the detected predefined situation when the manual mode is activated, and the control device 12 computes the maximum thrust threshold as a function of the predefined position of the throttle lever 11 associated with the detected predefined situation when the automatic thrust mode is activated.

Examples of predefined positions are, in ascending order of associated thrust, an idle position, a climb position, a maximum continuous thrust position and a maximum available thrust position. According to one embodiment, a predefined number of expected predefined positions exists for the throttle lever 11.

Each predefined situation represents a predefined flight situation or flight context, in which actuating the throttle lever 11 is deemed necessary in order to reach an expected predefined position. Each flight condition depends on flight parameters and on the current position of the throttle lever 11. An example of a predefined situation is a failure of the propulsion engine controlled by the control system 1. The flight condition for detecting this example is that an engine failure is detected and the current position of the throttle lever 11 is different from the idle position. Another example of a predefined situation is a requirement to go-around, with the associated flight condition being the detection of a requirement to go-around and a current position of the throttle lever 11 different from the maximum available thrust position.

Each predefined situation is associated with one of the predefined categories, with each of the predefined categories representing a piloting context. The predefined categories each define a degree of urgency for actuating the throttle lever 11, which depends on the predefined situation and the aptitude of a crew. According to a preferred embodiment, a first category corresponds to crew incapacitation. The validity condition for the first category is that the crew firstly must be declared unfit. The crew is declared unfit when the crew cannot physically actuate the throttle lever 11, for example, when the crew is absent from the cockpit during a physiological break or when the crew is physically incapacitated. A second category corresponds to a crew that is declared fit, with no emergency linked to the predefined situation. As long as the crew is not declared unfit, the validity condition for the second category is verified. A third category corresponds to an emergency, whether or not the crew is fit. The validity condition for the third category is always verified.

In order to verify the validity condition for a category, the automated selective modification device 100 retrieves, for example, data from an FMS (Flight Management System) or more generally from the avionics of the aircraft A in order to determine whether manual actions are carried out in the cockpit. For example, the crew is declared fit as long as manual actions are detected at intervals below a predetermined time period, or when an incapacitation indicator is deactivated or even when a movement is detected in the cockpit by a video camera, and the second and third categories then apply. However, the crew is declared unfit when no manual action has been detected for the predetermined time period, or when a crew incapacitation indicator is activated by the crew itself, for example, before the crew is absent, or even when no movement is detected in the cockpit by a video camera for a predetermined time period. The first and third categories then apply.

Furthermore, the predefined activation duration depends on the encountered predefined situation and on the category. For example, each first category predefined situation is associated with a zero predefined activation duration, so that when the crew has previously been declared unfit, a predefined situation requiring actuation of the throttle lever 11 will result in the position information being modified without delay. Similarly, each third category predefined situation is associated with a zero predefined activation duration, so that when a predefined situation requires urgent actuation of the throttle lever 11, the position information is modified without delay. However, each second category predefined situation is associated with a predefined activation duration that varies according to the considered predefined situation, and preferably is non-zero, so that the crew, having been declared fit, is able to actuate the throttle lever 11 before the position information is automatically modified.

For example, the predefined engine failure situation described above is associated with a first category predefined situation, with the associated activation duration then being zero.

According to another example, the predefined engine failure situation is associated with a second category predefined situation, with a non-zero activation duration, for example, equal to 4 minutes. The predefined position of the throttle lever 11 is an idle position.

The predefined go-around requirement situation is, for example, associated with a first category predefined situation, with a zero activation duration.

According to another example of a first category predefined situation, a flight condition is such that a lower altitude threshold is reached during a landing with a current position of the throttle lever 11 different from the idle position. The associated predefined position is the idle position, which allows the airbrakes to be deployed when the aircraft A touches down.

According to another example of a first category predefined situation, a flight condition is such that the aircraft A is in a taxiing phase and the associated predefined position is the idle position, which allows the aircraft A to stop automatically when the crew is incapacitated.

Examples of second category predefined situations are described hereafter. According to a first example, a flight condition is such that an upper altitude threshold is reached during a take-off or a go-around operation, and such that the current position of the throttle lever 11 remains above the climb position. The associated predefined position is the climb position with an associated non-zero activation duration. This allows the aircraft A to reduce the thrust and, according to a particular embodiment, to also engage the automatic thrust mode.

According to a second example, a flight condition is such that an engine failure is detected on another propulsion engine, with the associated predefined position being a maximum continuous thrust position with an associated non-zero activation duration. This compensates for the loss of thrust due to the failure of the other engine. According to a third example, within the context of an “economic” take-off, in other words a take-off with less thrust than the maximum available thrust, when a temperature threshold is not reached, the associated predefined position is the position of maximum available thrust with a non-zero associated activation duration, for example, of 8 seconds. This ensures safe take-off when the conditions required for an economic take-off are not met.

Examples of third category predefined situations are described hereafter. According to a first example, a flight condition is such that a take-off rejection is activated, which corresponds to a context whereby the take-off must be aborted, and such that the position of the throttle lever 11 is different from the idle position. The predefined position is the idle position, with a zero activation duration. According to a second example, a flight condition, defined within the context of a take-off, is such that a failure is detected on another propulsion engine and that a first speed threshold, called flight engagement threshold, is exceeded. The associated predefined position is the maximum available thrust position, with a zero activation duration.

According to a third example, a flight condition is such that the deployment of a thrust reverser is detected during a flight phase, in other words excluding landing and taxiing. The associated predefined position is the idle position with a zero activation duration. This ensures the stability of the aircraft A. According to a fourth example, a flight condition is such that an angle of attack of the aircraft A is greater than a predefined angle threshold, reflecting a risk of stalling, and such that the position of the throttle lever 11 is not at the maximum. The associated predefined position is the maximum available thrust position, with a zero activation duration. This allows the aircraft A to be accelerated in order to prevent the stalling.

According to a particular embodiment, each propulsion engine of the aircraft A is controlled by a control system 1 as illustrated in FIG. 1, with the aircraft A thus comprising as many automated selective modification devices 100 as there are propulsion engines.

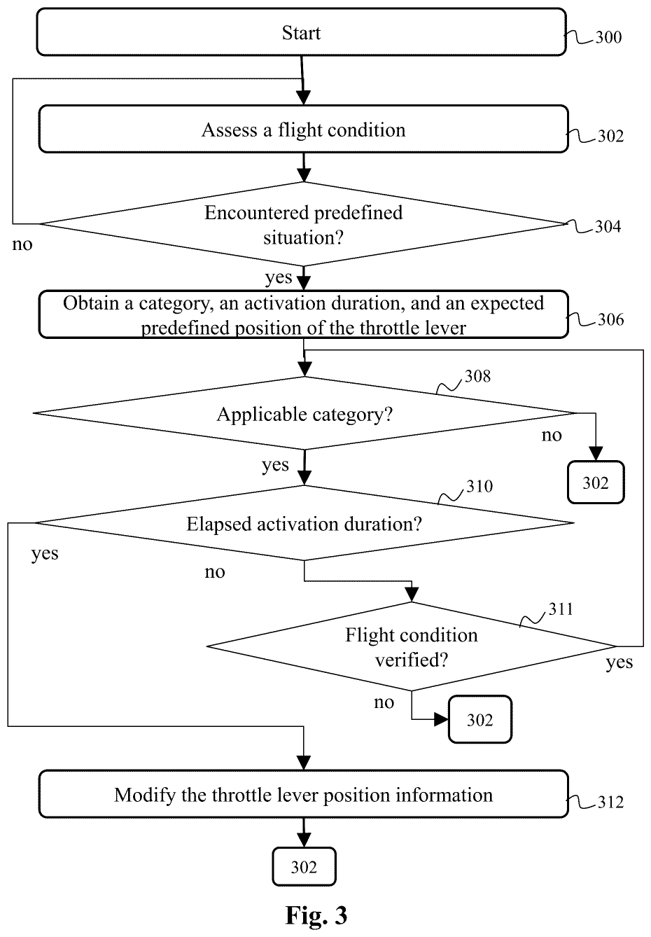

With reference to FIG. 3, a method for conditionally modifying information representing a position of a throttle lever 11, implemented by the automated selective modification device 100, comprises the following steps.

In a first step 300, the method is initialised, for example, when the automated selective modification device 100 is switched on or when the propulsion engine is switched on.

In a subsequent step 302, the automated selective modification device 100 assesses, for each predefined situation from the list of predefined situations, a flight condition associated with said predefined situation. For example, the automated selective modification device 100 monitors parameters of the aircraft A and compares them with each flight condition associated with a predefined situation from the list.

In a subsequent step 304, the automated selective modification device 100 determines whether a predefined situation is encountered and detected. When the automated selective modification device 100 determines that the flight condition associated with one of the predefined situations is verified, then said predefined situation is encountered and detected. If this is the case, then a step 306 is carried out. Otherwise, when no predefined situation is detected, the method returns to step 302.

In step 306, the automated selective modification device 100 obtains information associated with the detected predefined situation, namely a category, a predefined activation duration and a predefined position of the throttle lever 11 that is expected in the encountered predefined situation. According to one example, the automated selective modification device 100 polls a database storing, for each predefined situation, all the associated information, and thus retrieves said associated information. The automated selective modification device 100 also obtains or retrieves the validity condition of the obtained category.

In a subsequent step 308, the automated selective modification device 100 determines whether the category associated with the considered predefined situation is applicable, in other words whether the validity condition of said category is met. If this is the case, with the category being applicable, a step 310 is carried out. Otherwise, the method returns to step 302.

For example, for a first category predefined situation, the automated selective modification device 100 verifies whether the crew has previously been declared unfit. If so, the first category is applicable and step 310 is carried out. For a second category predefined situation, the automated selective modification device 100 verifies that the crew has not previously been declared unfit, and proceeds to step 310 if the crew is not declared unfit or returns to step 302 otherwise. For a third category predefined situation, the automated selective modification device 100 considers the validity condition to be still verified and then necessarily proceeds to step 310. In step 310, the automated selective modification device 100 determines whether the predefined activation duration associated with the detected predefined situation has elapsed since the considered predefined situation was detected. If so, a step 312 is carried out. If not, a step 311 is carried out.

In step 311, the automated selective modification device 100 determines whether the flight condition associated with the predefined situation is still verified. If so, the method returns to step 308. If not, the method returns to step 302. Thus, for a second category predefined situation, if the crew has actuated the throttle lever 11 as deemed necessary in the considered predefined situation and the flight condition is then no longer verified, the position information of the throttle lever 11 no longer needs to be automatically modified.

In step 312, the automated selective modification device 100 modifies the information representing the current position of the throttle lever 11 received from the throttle lever 11, by replacing the current position of the throttle lever 11 with the expected predefined position of the throttle lever 11 in the detected predefined situation, then transmits said modified information, representing said predefined position, to the control device 12.

The method then returns to step 302.

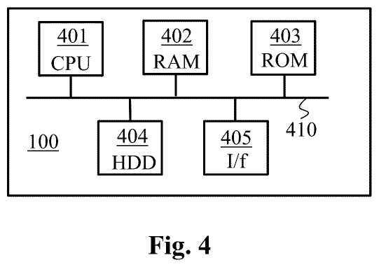

FIG. 4 schematically illustrates an example of a hardware platform for implementing the automated selective modification device 100 in the form of electronic circuitry.

The hardware platform comprises, connected by a communication bus 410: a processor or CPU (Central Processing Unit) 401; a RAM (Random-Access Memory) 402; a ROM (Read Only Memory) or EEPROM (Electrically-Erasable Programmable ROM) 403, for example, such as a Flash memory; a storage unit, such as an HDD (Hard Disk Drive) 404, or a storage medium reader, such as an SD (Secure Digital) card reader; and an I/f interface manager 405.

The I/f interface manager 405 allows the automated selective modification device 100 to interact with the throttle lever 11, with the control device 12 and with equipment on the aircraft A, such as sensors and avionics, in order to receive predefined parameter values.

The processor 401 is capable of executing instructions loaded into the random access memory 402 from the read-only memory 403, an external memory, a storage medium (such as an SD card), or a communications network. When the hardware platform is powered up, the processor 401 is able to read instructions from the RAM 402 and to execute them. These instructions form a computer program causing the processor 401 to implement some or all of the steps, methods and operations described herein.

All or some of the steps, methods and functions described herein thus can be implemented in software form by a set of instructions executed by a programmable machine, for example, a DSP (Digital Signal Processor) type processor or a microcontroller, or can be implemented in hardware form by a machine or a dedicated electronic component (chip) or a dedicated set of electronic components (chipset), for example, an FPGA (Field Programmable Gate Array) or ASIC (Application Specific Integrated Circuit) component. In general, the automated selective modification device 100 comprises electronic circuitry adapted and configured to implement the functions, methods and steps described herein.

1. A method for the selective automated modification of position information for a throttle lever associated with an aircraft propulsion engine, the method being implemented by a device configured to receive position information representing a current position of the throttle lever, wherein the method comprises the following steps of:
determining that a predefined situation from a list of predefined situations is encountered when a condition, called flight condition, associated with the predefined situation is verified, with each predefined situation representing a flight situation in which actuating the throttle lever is deemed necessary;
obtaining, for each encountered predefined situation, a category associated with said predefined situation, with each predefined situation being associated with a category from among predefined categories and each category representing a predefined piloting context, and obtaining a predefined activation duration associated with the encountered predefined situation and an expected predefined position of the throttle lever in said encountered predefined situation;
assessing a condition, called validity condition, associated with the obtained category;
modifying the received position information, by replacing the current position of the throttle lever with the obtained expected predefined position of the throttle lever when the flight condition associated with the encountered predefined situation and the validity condition of the category associated with said predefined situation are simultaneously verified for a duration at least equal to said obtained predefined activation duration; and
sending the modified position information in the event of a modification, and the received position information otherwise, to a control device for controlling the propulsion engine.

2. The method according to claim 1, wherein the predefined categories comprise a first category having a verified validity condition when a crew is previously declared unfit, and wherein the activation duration, associated with each first category predefined situation, is zero.

3. The method according to claim 1, wherein the predefined categories comprise a second category having a verified validity condition when a crew is not previously declared unfit, and wherein the activation duration, associated with each second category predefined situation, depends on the predefined situation.

4. The method according to claim 1, wherein the predefined categories comprise a third category having an always verified validity condition, and wherein the activation duration, associated with each third category predefined situation, is zero.

5. The method according to claim 1, wherein the expected predefined position of the throttle lever associated with at least one predefined situation from the list of predefined situations comprises a first predefined position and a second predefined position, and wherein modifying the received position information by replacing the current position of the throttle lever with the obtained expected predefined position of the throttle lever comprises:
carrying out a first modification of the position information by replacing the current position of the throttle lever with the first predefined position; and
carrying out, after a predefined time associated with the predefined situation has elapsed, a second modification of the position information by replacing the current position of the throttle lever with the second predefined position.

6. A device for the selective automated modification of position information for a throttle lever of an aircraft propulsion engine, the automated selective modification device comprising electronic circuitry configured to receive position information representing a current position of the throttle lever, the automated selective modification device comprises electronic circuitry configured for:
determining that a predefined situation from a list of predefined situations is encountered when a condition, called flight condition, associated with the predefined situation is verified, with each predefined situation representing a flight situation in which actuating the throttle lever is deemed necessary;
obtaining, for each encountered predefined situation, a category associated with said predefined situation, with each predefined situation being associated with a category from among predefined categories and each category representing a predefined piloting context, and obtaining a predefined activation duration associated with the encountered predefined situation and an expected predefined position of the throttle lever in said encountered predefined situation;
assessing a condition, called validity condition, associated with the obtained category;
modifying the received position information, by replacing the current position of the throttle lever with the obtained expected predefined position of the throttle lever, when the flight condition associated with the encountered predefined situation and the validity condition of the category associated with said predefined situation are simultaneously verified for a duration at least equal to said obtained predefined activation duration; and
sending the modified position information in the event of a modification, and the received position information otherwise, to a control device for controlling the propulsion engine.

7. An aircraft comprising an automated selective modification device according to claim 6.

8. (canceled)

9. A non-transitory storage medium, storing a computer program comprising instructions causing a processor to execute the method according to claim 1, when said instructions are read and executed by the processor.
